(19) United States
(12) Patent Application Publication
(10) Pub. No.: US 2012/0291986 A1
(43) Pub. Date: Nov. 22, 2012

(54) HVAC DEVICE WITH FOOTWELL OUTLET

(75) Inventor: Gerald Richter, Aachen (DE)

(73) Assignee: VISTEON GLOBAL TECHNOLOGIES, INC., Van Buren Twp., MI (US)

(21) Appl. No.: 13/474,864

(22) Filed: May 18, 2012

(30) Foreign Application Priority Data
May 18, 2011 (DE) 10 2011 050 457.5

(51) Int. Cl. B60H 1/32

(52) U.S. Cl. 165/42

(57) ABSTRACT

A heating, ventilating, and air conditioning device includes a footwell outlet, where the footwell outlet is positioned such that the accompanying air channel can preferably run at the front wall in direction of the tunnel. A design of the HVAC device is suitable for compact dashboard structures. In particular, the HVAC device enables the use of a flying dashboard architecture.

### CROSS-REFERENCE TO RELATED APPLICATION

This application claims the benefit of German Patent Application No. DE 10 2011 050 457.5 filed May 18, 2011, the entire disclosure of which is hereby incorporated herein by reference.

### FIELD OF THE INVENTION

The invention relates to a heating, ventilating, and air conditioning (HVAC) device, and more particularly an HVAC device with a footwell outlet for a rear area of the vehicle disposed below an evaporator and between a front wall of a casing and a center of the HVAC device.

### BACKGROUND OF THE INVENTION

HVAC devices typically include a casing having a heat exchanger (i.e. an evaporator) for cooling a fluid flowing therein and another heat exchanger (i.e. a heater core) for heating the fluid. In certain instances, an additional electrical heater may be included in the HVAC device. Such HVAC devices include footwell outlets on a rear side of the casing in respect of a direction of travel of the fluid through the HVAC device. Arrangement of the footwell outlets on the rear side is particularly well-suited if the heat exchangers, especially the evaporator, are arranged relatively vertical (e.g. at an angle greater than 45° in respect to a horizontal plane) in the casing. Accordingly, this arrangement of the footwell outlets is particularly advantageous in typical dashboard configurations. However, in other configurations of the dashboard such as a so-called flying architecture where an otherwise usual center console is not present, special demands on the HVAC device result, especially in the rear footwell outlet.

DE 199 62 097 A1 discloses a vehicle HVAC system that is apart from outlets for a defroster and a passenger compartment provided with an outlet for a footwell. The disclosed vehicle HVAC system, however, does not facilitate a compact dashboard design because heat exchangers and damper doors are positioned vertically above each other. While the footwell outlet is located below an evaporator, it is not provided in an area of a front wall of a casing of the vehicle HVAC system.

DE 199 53 565 A1 discloses a vehicle HVAC system with evaporators arranged relatively horizontal. Air to be conditioned enters the vehicle HVAC system through an air passage located below one of the evaporators and passes through the evaporator from a bottom to a top. Depending on a door position, a heater core is passed through or, alternatively, bypassed. Outlets for a passenger compartment and a defroster are above a heater core. The footwell channel is provided in front of the HVAC device in respect of a direction of an engine bay. Such an HVAC device is not suitable for a vehicle with a flying dashboard architecture. Moreover, the HVAC device is not mountable in limited space. In addition, the outlet is not placed adjacent to the front wall.

U.S. Pat. No. 6,311,763 discloses an HVAC device for vehicles with an evaporator and a heater core arranged relatively vertical. Outlets for front and rear footwells are positioned, in respect of a direction of travel, at a back of the HVAC device. As such, the HVAC system is not suitable for a vehicle with a flying dashboard architecture having no center console.

Therefore it is an object of the invention to provide an HVAC device with a footwell outlet such that an air channel can be guided on the front wall in a direction of a tunnel, thus enabling a flying dashboard architecture.

### SUMMARY OF THE INVENTION

In concordance and agreement with the present invention, an HVAC device having a footwell outlet located in a front wall thereof, has been surprisingly invented.

In one embodiment, an HVAC device for a vehicle comprises: a hollow casing having a front wall in respect of a direction of travel of the vehicle, the hollow casing having a plurality of outlets formed therein; and an evaporator disposed within the casing adjacent the front wall of the casing, wherein one of the outlets is disposed below the evaporator and adjacent the front wall of the casing.

In another embodiment, an HVAC device for a vehicle comprises: a hollow casing having a front wall in respect of a direction of travel of the vehicle, the hollow casing having a ventilation outlet, a defroster outlet, and a footwell outlet for a rear area of the vehicle formed therein; a heat exchanger disposed within the casing; and an evaporator disposed within the casing adjacent the front wall of the casing, wherein the footwell outlet is disposed below the evaporator and adjacent the front wall of the casing.

In yet another embodiment, an HVAC device for a vehicle comprises: a hollow casing disposed in a dashboard of the vehicle, the dashboard provided without a center console and the casing having a front wall in respect of a direction of travel of the vehicle, wherein the hollow casing includes a ventilation outlet, a defroster outlet, and a footwell outlet for a rear area of the vehicle formed therein; a heat exchanger disposed within the casing; an evaporator disposed within the casing adjacent the front wall of the casing, wherein the footwell outlet is disposed below the evaporator and between the front wall of the casing and a center of the HVAC device; and a channel routing extending from the footwell outlet to a rear of the vehicle.

The footwell outlet is located below the evaporator in the area of the front wall so that a channel routing can also be located in the area of the front wall. The footwell outlet is provided in the front wall so that, with the complete functionality of the HVAC system maintained, mounting space advantages result in the rear area of the HVAC system. The HVAC device according to the present invention includes an efficient, integrated air ducting. The placement of the footwell outlet for rear passengers simplifies assembling a channel system to the front wall. Tapping within the HVAC device is made at an optimum position regarding temperature demands. Due to the integrated air ducting no free space is needed between a ventilation channel and the HVAC device so that the mounting space can be minimized. The simplified routing of the air outlet requires a smaller number of joints, resulting in a smaller number of potential leakage points. Alternatively, the rear footwell outlet can be placed in a Z-direction below the evaporator and in an X-direction between the front wall and the center of the HVAC device.

Advantages of the invention over prior art are that a simplified assembly of the HVAC device is made possible and the number of components of the HVAC device is minimized. Further, it should be understood that during assembly of the HVAC device into the vehicle, a connection to the air channel of the vehicle at the front wall can be made automatically, which results in improved efficiency and cost savings.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic cross-sectional view of an HVAC device of prior art for a flat dashboard;

FIG. 2 is a schematic cross-sectional view of a mounting situation of an HVAC device for a flat dashboard with traditional channel routing;

FIG. 3 is a schematic cross-sectional view of a mounting situation of an HVAC device for a flat dashboard with free mounting space in a center thereof;

FIG. 4 is a schematic cross-sectional view of a routing of an air channel for a vehicle rear with free mounting space in a vehicle center;

FIG. 5 is a schematic cross-sectional view of an HVAC device according to an embodiment of the invention with a footwell outlet adjacent to a front wall; and

FIG. 6 is a schematic cross-sectional view of a mounting situation of the HVAC device illustrated in FIG. 5 in a flat dashboard with free mounting space in a vehicle center.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

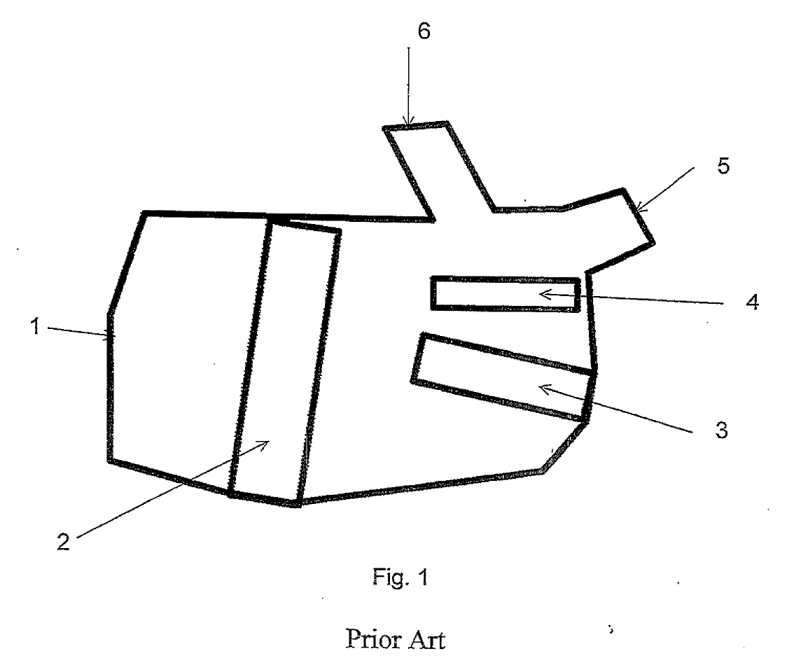

In FIG. 1, an HVAC device 1 of prior art is shown. The HVAC device 1 is for a mounting in a flat dashboard. In the HVAC device 1, an evaporator 2 for cooling, a heat exchanger 3 for heating (i.e. a heater core), and a footwell outlet 4 for a rear area of a vehicle are shown. An outlet for a vehicle compartment ventilation 5 and an outlet for a defroster 6 are located above the footwell outlet 4 for the rear area. Adjacent to the footwell outlet 4 for the rear area, a footwell outlet (not shown) for a front area of a passenger compartment of the vehicle is positioned.

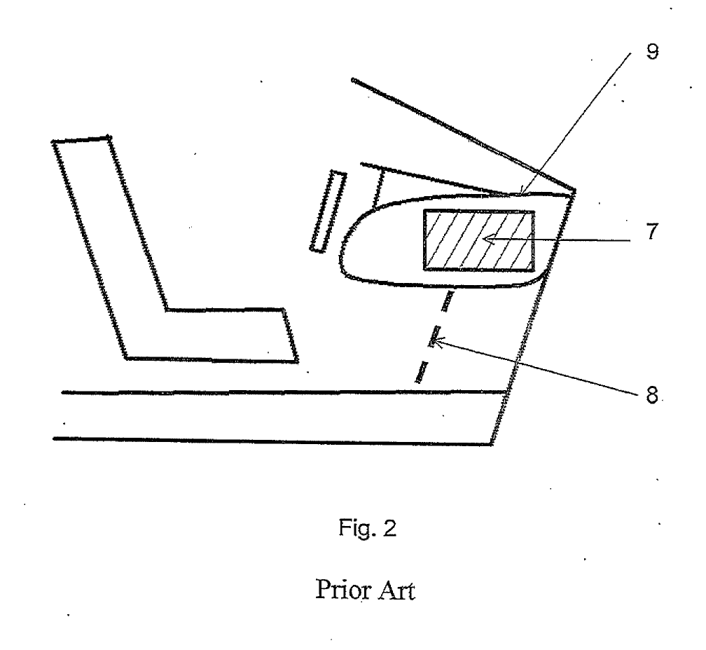

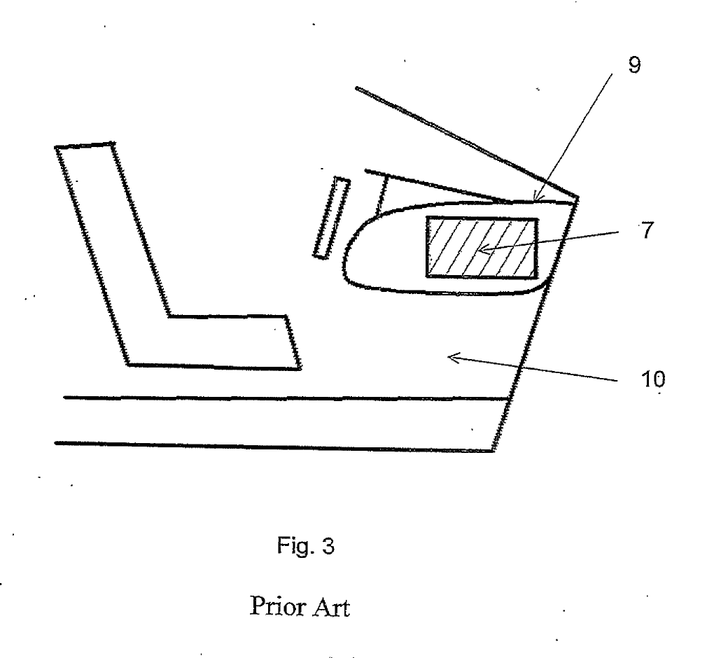

In FIG. 2, the front area of the vehicle compartment is schematically shown. In a flat dashboard 9, a mounting space 7 for the HVAC device 1 is shown as hatched area. To direct air processed in the HVAC device 1 into the rear footwell, a traditional channel routing 8 is usually provided, as shown by dashed line. The traditional channel routing 8 does not permit a free mounting space 10 in a vehicle center, as shown in FIG. 3.

FIG. 3 shows the front area of the vehicle compartment. Free mounting space 10 in the vehicle center is represented without disturbing components so that impression of a flying dashboard architecture can develop. Therefore, the vehicle compartment, in the whole, is more spacious. The flat dashboard 9 with the mounting space 7 for the HVAC device 1 corresponds to the flat dashboard 9 with the mounting space 7 shown in FIG. 2.

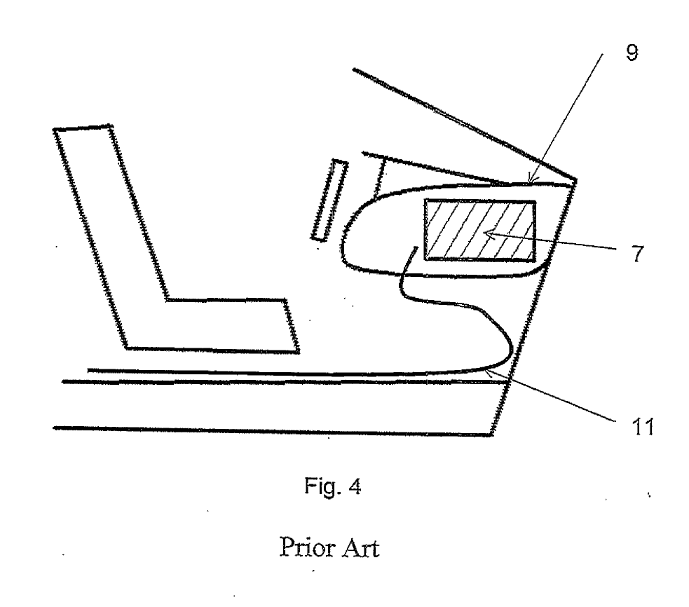

In FIG. 4, the front area of the vehicle compartment is as shown in FIGS. 2 and 3. The air is processed in the HVAC device 1. If the air directed into the rear area is from a footwell outlet located in the rear area of the HVAC device 1, the resulting channel routing 11 is expensive because the air from the footwell outlet for the rear area has to flow around the HVAC device 1 to the front wall.

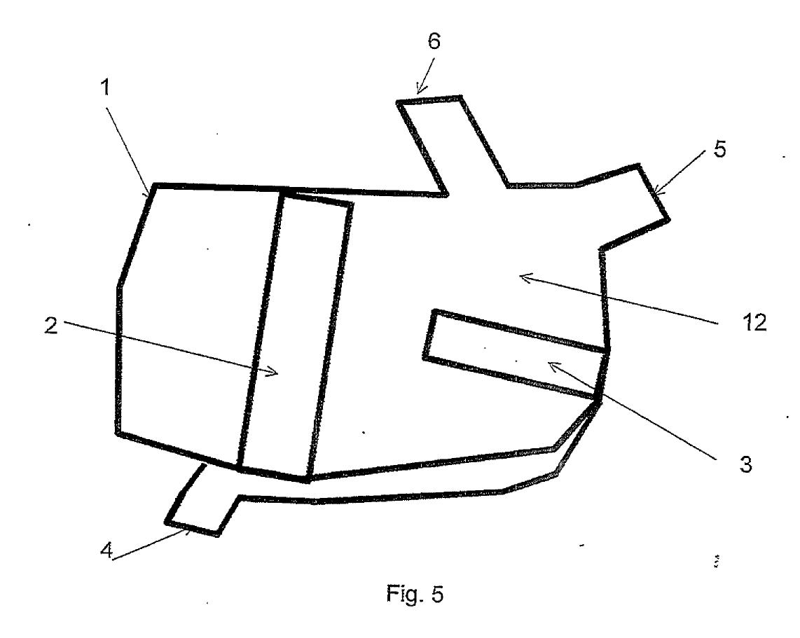

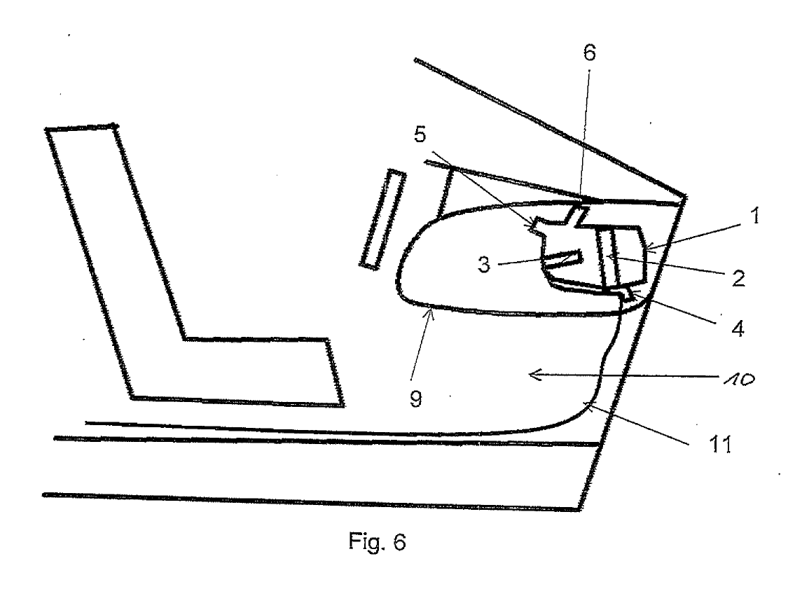

In FIG. 5, an HVAC device 1 according to the invention is shown. The evaporator 2 for cooling, the heat exchanger 3 for heating, the outlet 5 for the vehicle compartment ventilation, the outlet 6 for the defroster and the footwell outlet 12 are arranged in the front area of the vehicle compartment. The footwell outlet 4 for the channel routing configured to pass the air processed in the HVAC device 1 into the rear area is placed below the HVAC device 1 directed to the front, in respect of a direction of travel. This enables optimum air ducting. The processed air is tapped within the HVAC device 1 at the optimum position as to the temperature demand. Due to the location of the footwell outlet 4, simplified assembly and a simpler channel system at the front wall are possible. The integrated air ducting results in a reduced mounting space for the HVAC device 1. Free space between the channel 11 shown in FIG. 6 and the HVAC device 1 is not needed.

FIG. 6 shows the front passenger compartment with the free mounting space 10 provided in the vehicle center so that no center console exists. The HVAC device 1 is located in the flat dashboard 9. In the HVAC device 1, the evaporator 2 for cooling, the heat exchanger 3 for heating, and the outlets 5, 6 for the respective compartment ventilation and the defroster are shown. The footwell outlet 4 for the channel routing 11 passing the air processed in the HVAC device 1 is positioned at the bottom of the HVAC device 1 offset in the direction of travel. This enables the footwell outlet 4 to be connected to the channel routing 11 in a simple manner. Thus, the channel routing 11 can be established in a simple way adjacent to the front wall.

From the foregoing description, one ordinarily skilled in the art can easily ascertain the essential characteristics of this invention and, without departing from the spirit and scope thereof, make various changes and modifications to the invention to adapt it to various usages and conditions.

### NOMENCLATURE

1 HVAC device
2 evaporator for cooling
3 heater exchanger for heating
4 footwell outlet for a rear area
5 outlet for the vehicle compartment ventilation
6 outlet for the defroster
7 mounting space for the HVAC device
8 classical channel routing for the rear area
9 flat cockpit without center console
10 free mounting space in the vehicle center
11 channel routing for the rear area in an HVAC device of state-of-the art
12 footwell outlet for the front compartment

What is claimed is:

1. A heating, ventilating, and air conditioning (HVAC) device for a vehicle comprising:
a hollow casing having a front wall in respect of a direction of travel of the vehicle, the hollow casing having a plurality of outlets formed therein; and
an evaporator disposed within the casing adjacent the front wall of the casing, wherein one of the outlets is disposed below the evaporator and adjacent the front wall of the casing.

2. The HVAC device according to claim 1, wherein the one of the outlets is a footwell outlet for a rear area of the vehicle.

3. The HVAC device according to claim 1, wherein the one of the outlets is disposed between the front wall and a center of the HVAC device.

4. The HVAC device according to claim 1, further comprising a channel routing extending from the one of the outlets to a rear area of the vehicle.

5. The HVAC device according to claim 4, wherein the channel routing is configured as a channel disposed along the front wall of the casing.

6. The HVAC device according to claim 1, wherein the one of the outlets is disposed below the evaporator to provide a free mounting space in a vehicle center.

7. The HVAC device according to claim 6, wherein the free mounting space in the vehicle center facilitates use of a dashboard configuration without a center console.

8. The HVAC device according to claim 1, further comprising a heat exchanger disposed in the casing.

9. The HVAC device according to claim 8, wherein another one of the outlets is disposed above the heat exchanger.

10. The HVAC device according to claim 9, wherein the another one of the outlets is one of a ventilation outlet and a defroster outlet.

11. The HVAC device according to claim 1, wherein the one of the outlets permits use of the HVAC device in vehicles where no free space is provided between dashboard and a tunnel extending along a floorboard of the vehicle.

12. A heating, ventilating, and air conditioning (HVAC) device for a vehicle comprising:
a hollow casing having a front wall in respect of a direction of travel of the vehicle, the hollow casing having a ventilation outlet, a defroster outlet, and a footwell outlet for a rear area of the vehicle formed therein;
a heat exchanger disposed within the casing; and
an evaporator disposed within the casing adjacent the front wall of the casing, wherein the footwell outlet is disposed below the evaporator and adjacent the front wall of the casing.

13. The HVAC device according to claim 12, wherein the footwell outlet is disposed between the front wall and a center of the HVAC device.

14. The HVAC device according to claim 12, further comprising a channel routing extending from the footwell outlet to a rear area of the vehicle.

15. The HVAC device according to claim 14, wherein the channel routing is configured as a channel disposed along a wall of the vehicle.

16. The HVAC device according to claim 12, wherein the ventilation outlet is disposed above the heat exchanger.

17. The HVAC device according to claim 12, wherein the defroster outlet is disposed above the heat exchanger.

18. A heating, ventilating, and air conditioning (HVAC) device for a vehicle comprising:
a hollow casing disposed in a dashboard of the vehicle, the dashboard provided without a center console and the casing having a front wall in respect of a direction of travel of the vehicle, wherein the hollow casing includes a ventilation outlet, a defroster outlet, and a footwell outlet for a rear area of the vehicle formed therein;
a heat exchanger disposed within the casing;
an evaporator disposed within the casing adjacent the front wall of the casing, wherein the footwell outlet is disposed below the evaporator and between the front wall of the casing and a center of the HVAC device; and
a channel routing extending from the footwell outlet to a rear of the vehicle.

19. The HVAC device according to claim 18, wherein the channel routing is disposed along a front wall of the dashboard.

20. The HVAC device according to claim 16, wherein at least one of the ventilation outlet and the defroster outlet is disposed above the heat exchanger.
